(19) United States
(12) Patent Application Publication
(10) Pub. No.: US 2024/0185096 A1
(43) Pub. Date: Jun. 6, 2024

(54) A Method, Device and Storage Medium for Knowledge Recommendation

(71) Applicant: Siemens Aktiengesellschaft, München (DE)

(72) Inventors: Bin Zhang, Beijing (CN); Armin Roux, Höchstadt a. d. Aisch (DE); Zhu Niu, Beijing (CN); Shun Jie Fan, Beijing (CN)

(73) Assignee: Siemens Aktiengesellschaft, München (DE)

(21) Appl. No.: 18/574,403

(22) PCT Filed: Jun. 29, 2021
(86) PCT No.: PCT/CN2021/103284

§ 371 Date: Dec. 27, 2023

(51) Int. Cl. G06N 5/022

(52) U.S. Cl. CPC G06N 5/022

(57) ABSTRACT

Various embodiments of the teachings herein include a method for knowledge recommendation. The method may include: obtaining current searching information of a user for certain knowledge in factory production, job characteristic information of the user, and historical feedback information of the user for at least one knowledge item and/or knowledge resource in the past; using a first prediction algorithm model for learning based on historical searching information, job feature information, and historical feedback information of the user and other users to analyze obtained information, to obtain first prediction information including a first number of knowledge items; using a second prediction algorithm model to perform fusion sorting on the first prediction information and thereby obtain second prediction information including a second number of knowledge items; providing the second number of knowledge items to a knowledge recommendation model; and recommending a knowledge resource output from the model.

### CROSS-REFERENCE TO RELATED APPLICATIONS

This application is a U.S. National Stage Application of International Application No. PCT/CN2021/103284 filed Jun. 29, 2021, which designates the United States of America, the contents of which are hereby incorporated by reference in their entirety.

### TECHNICAL FIELD

The present disclosure relates to digital factory technologies. Various embodiments of the teachings herein include methods, devices, and computer readable storage medium for knowledge recommendation.

### BACKGROUND

Digital technology refers to a technology with which computers and networks are used to achieve digital. Digital technology has been applied to a variety of industries and fields, such as traditional manufacturing plants. A digital factory provides digital and information services for traditional manufacturing plants by using computer hardware and software technology. A digital factory integrates various systems and databases of factory, product and control, and improves the flexibility and efficiency of factory manufacturing process by means of visualization, simulation and big data.

In modern digital factories, knowledge updating is very rapid, so users need to learn from time to time, or ask relevant technicians or experts for help when they are in doubt. However, users sometimes don't know what specific content to learn even if they want to learn, or where to find technicians or experts who can solve their doubts. Therefore, a flexible knowledge learning or coaching system is needed.

### SUMMARY

Some embodiments of the teachings of the present disclosure include methods, devices, and computer readable storage medium for knowledge recommendation to achieve the intelligent knowledge recommendation in the digital factory.

As an example, some embodiments include a method for knowledge recommendation comprising: obtaining current searching information of a for certain knowledge in factory production, job characteristic information of the user, and historical feedback information of the user for at least one knowledge item and/or knowledge resource in the past; using a first prediction algorithm model for learning based on historical searching information, job feature information and historical feedback information of the user and other users to analyze obtained information, and obtaining first prediction information including a first number of knowledge items; using a second prediction algorithm model to perform fusion sorting on the first prediction information to obtain second prediction information including a second number of knowledge items; the first number is greater than the second number, and the second number is greater than or equal to 1; inputting the second number of knowledge items to a knowledge recommendation model, and recommending at least one knowledge resource output by the knowledge recommendation model to the user; the knowledge recommendation model is obtained by training with training samples formed by establishing corresponding relationship between various knowledge resources involved in factory production and corresponding knowledge items, wherein the knowledge items are taken as input samples and corresponding knowledge resources are taken as output samples.

In some embodiments, the first prediction algorithm model is an algorithm model realized by a logistic regression algorithm or a collaborative filtering algorithm; the second prediction algorithm model is a CTR model realized by gradient boost decision tree algorithm+logistic regression algorithm or gradient boost decision tree algorithm+factorization machine algorithm.

In some embodiments, before inputting the second number of knowledge items to a knowledge recommendation model, the method further includes: providing the second prediction information including the second number of knowledge items to the user for confirmation, and receiving first feedback information of the user for the second number of knowledge items; and correcting the second prediction information according to the first feedback information to obtain a corrected second number of knowledge items.

In some embodiments, the method further includes providing the first feedback information or corrected second prediction information to the first prediction algorithm model for learning.

In some embodiments, the method further includes receiving second feedback information of the user for at least one knowledge resource recommended and providing the second feedback information to the first prediction algorithm model for learning.

In some embodiments, the method further includes providing the second number of knowledge items and a knowledge resource with which the user interacts more as a training sample to the knowledge recommendation model for further training.

As another example, some embodiments include a device for knowledge recommendation comprising: a data obtaining module, to obtain current searching information of a user for certain knowledge in factory production, job characteristic information of the user, and historical feedback information of the user for at least one knowledge item and/or knowledge resource in the past; a first prediction module, to use a first prediction algorithm model for learning based on historical searching information, job feature information and historical feedback information of the user and other users to analyze information obtained by the data obtaining module, and to obtain first prediction information including a first number of knowledge items; a second prediction module, to use a second prediction algorithm model to perform fusion sorting on the first prediction information to obtain second prediction information including a second number of knowledge items; the first number is greater than the second number, and the second number is greater than or equal to 1; and a knowledge recommendation module, to input the second number of knowledge items to a knowledge recommendation model, and recommend at least one knowledge resource output by the knowledge recommendation model to the user; the knowledge recommendation model is obtained by training with training samples formed by establishing a corresponding relationship between various knowledge resources involved in factory production and corresponding knowledge items, wherein the knowledge items are taken as input samples and corresponding knowledge resources are taken as output samples.

In some embodiments, the device further includes a prediction information confirmation module to provide the second prediction information including the second number of knowledge items to the user for confirmation and receive first feedback information of the user for the second number of knowledge items, to correct the second prediction information according to the first feedback information.

In some embodiments, the prediction information confirmation module provides the first feedback information and/or the corrected second prediction information to the first prediction algorithm model for learning.

In some embodiments, the device further includes a knowledge resource confirmation module to receive second feedback information of the user for at least one recommended knowledge resource and provide the second feedback information to the first prediction algorithm model for learning.

In some embodiments, the knowledge resource confirmation module provides the second number of knowledge items and a knowledge resource with which the user interacts more as a training sample to the knowledge recommendation model for further training.

As another example, some embodiments include a device for knowledge recommendation comprising: at least one memory to store a computer program; and at least one processor to call the computer program stored in the at least one memory to perform one or more of the methods described herein.

As another example, some embodiments include a non-transitory computer-readable storage medium storing a computer program to be executed by one or more processors to implement one or more of the methods for knowledge recommendation described herein.

### BRIEF DESCRIPTION OF THE DRAWINGS

For a better understanding of the present disclosure, reference should be made to the Detailed Description below, in conjunction with the following drawings in which like reference numerals refer to corresponding parts throughout the figures. In the Figures:

FIG. 1 is a flow diagram illustrating a method for knowledge recommendation incorporating teachings of the present disclosure;

FIG. 2 is a schematic diagram illustrating a device for knowledge recommendation incorporating teachings of the present disclosure; and

FIG. 3 is a schematic diagram illustrating another device for knowledge recommendation incorporating teachings of the present disclosure.

The reference numerals are as follows:

| Reference numeral | Object |
|---|---|
| 101~104 | processes |
| 21 | data obtaining module |
| 22 | first prediction module |
| 23 | second prediction module |
| 24 | knowledge recommendation module |
| 25 | prediction information confirmation module |
| 26 | knowledge resource confirmation module |
| 41 | memory |
| 42 | processor |
| 43 | bus |

### DETAILED DESCRIPTION

It can be seen from the above mentioned embodiments, a knowledge recommendation model may be obtained by training with training sample formed by establishing the corresponding relationship between various knowledge resources involved in factory production and corresponding various knowledge items. Then, a first prediction algorithm model is used to perform analysis on currently obtained current searching information of a user for a certain knowledge in factory production, as well as job characteristic information of the user, the historical feedback information of the user for at least one knowledge item and/or knowledge resource in the past to obtain the first prediction information including the first number of knowledge items; a second prediction algorithm model is used to perform fusion sorting on the first prediction information to obtain the second prediction information including the second quantity knowledge item; the second number of knowledge items are input to the knowledge recommendation model, and at least one knowledge resource output by the knowledge recommendation model is recommended to the user. Therefore, the knowledge recommendation in factory production is realized.

In addition, by providing the second prediction information including the second number of knowledge items to the user for confirmation, receiving the first feedback information of the user for the second number of knowledge items, and correcting the second prediction information according to the first feedback information, the accuracy of the recommendation can be improved. By providing the first feedback information and/or the corrected second prediction information to the first prediction algorithm model for learning, the prediction accuracy of the first prediction algorithm model can be improved.

Furthermore, the prediction accuracy of the first prediction algorithm model can be further improved by receiving the second feedback information of the user for at least one recommended knowledge resource and providing the second feedback information to the first prediction algorithm model for learning. In addition, by providing the second number of knowledge items and a knowledge resource with which the user interacts more as a training sample to the knowledge recommendation model for further training, the recommendation accuracy of the knowledge recommendation model can be improved.

In some embodiments, in order to meet the knowledge recommendation for various knowledge needs in the digital factory, a corresponding relationship between the knowledge resources such as technical explanation, technical training, information description, and technical personnel characteristic information in the form of video, audio, picture, document or others and the corresponding knowledge items is established to form corresponding training samples training a knowledge recommendation model. The knowledge items may be input samples and the knowledge resources may be output samples.

Then, user's job feature information, the user's current searching information for a certain knowledge in factory production, and the user's past feedback information for at least one knowledge item and/or knowledge resource are obtained; obtained information is analyzed using a first prediction algorithm model for learning based on the job characteristic information, historical searching information and historical feedback information of the user and other users, and first prediction information including a first number of knowledge items is obtained; the second prediction algorithm model is used to perform fusion sorting on the first prediction information to obtain the second prediction information including a second number of knowledge items; the first number is greater than the second number, and the second number is greater than or equal to 1; the second number of knowledge items is taken as the input of the knowledge recommendation model and recommending at least one knowledge resource output by the knowledge recommendation model to the user.

In some embodiments, the second prediction information including the second number of knowledge items can be provided to the user for confirmation, the second prediction information can be corrected according to the feedback of the user, and the corrected second prediction information can be provided to the first prediction algorithm model for learning.

In some embodiments, feedback information for at least one knowledge resource recommended may further received from users, and the second number of knowledge items and a knowledge resource with which the user interacts more may be provided as a training sample to the knowledge recommendation model for training.

Reference will now be made in detail to examples, which are illustrated in the accompanying drawings. In the following detailed description, numerous specific details are set forth to provide a thorough understanding of the present disclosure. Also, the figures are illustrations of an example embodiments, in which modules or procedures shown in the figures are not necessarily essential for implementing the present disclosure. In other instances, well-known methods, procedures, components, and circuits have not been described in detail so as not to unnecessarily obscure aspects of the examples.

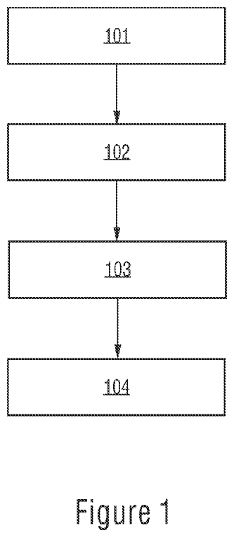

FIG. 1 is a flow diagram illustrating a method for knowledge recommendation incorporating teachings of the present disclosure. As shown in FIG. 1, the method may include the following processes:

At block 101, current searching information of a user for certain knowledge in factory production, job characteristic information of the user, and historical feedback information of the user for at least one knowledge item and/or knowledge resource in the past are obtained. In the illustrated implementation, the original data of the current searching information of the user can be submitted in various ways. For example, it can be submitted in the form of text such as search terms, or in the form of multimedia content such as video, audio, pictures, etc.

In addition, the current searching information can also include both text and multimedia content. The original data submitted by the user can be received by the robot, such as the data collection module of a knowledge transmission robot. Then, according to the different forms of original data submitted by the user, the corresponding information processing module can be used for information recognition and feature extraction to obtain the current searching information in standard format. For example, image recognition module may be used for image data, video analysis module may be used for video data, audio analysis module may be used for audio data, audio and video analysis module may be used for audio and video data, and text analysis module may be used for text data.

The job feature information of the user may be job feature information registered by the user in the factory system. For example, it can include technical position, age, gender, education background, major, etc. The historical feedback information of the user for at least one knowledge item or knowledge resource in the past may include the user-past click rate and browsing times for each knowledge item or knowledge resource recorded by the system.

At block 102, a first prediction algorithm model for learning based on historical searching information, job feature information and historical feedback information of the user and other users is used to analyze obtained information, and first prediction information including a first number of knowledge items is obtained. In this block, the first prediction algorithm model can be achieved by logistic regression (LR) algorithm or collaborative filtering (CF) algorithm. The first prediction algorithm model may learn based on the historical searching information, job feature information and historical feedback information of the user and other users.

At block 103, a second prediction algorithm model is used to perform fusion sorting on the first prediction information to obtain second prediction information including a second number of knowledge items. The first number is greater than the second number, and the second number is greater than or equal to 1. In this block, the second prediction algorithm model can be a CTR model achieved by gradient boost decision tree (GBDT) algorithm+logistic regression (LR) algorithm or GBDT algorithm+factorization machine (FM) algorithm. In some embodiments, the process of performing fusion sorting on the first prediction information may include: performing feature selection of dense features, discrete features splicing and feature training on the first prediction information.

At block 104, the second number of knowledge items are provided to a knowledge recommendation model, and at least one knowledge resource output by the knowledge recommendation model is recommended to the user. The knowledge recommendation model is obtained by training with training samples formed by establishing corresponding relationship between various knowledge resources involved in factory production and corresponding knowledge items, wherein the knowledge items are taken as input samples and corresponding knowledge resources are taken as output samples.

The knowledge resources may include technical explanation, technical training, information description, technical personnel characteristic information and other knowledge resources involved in factory production in the form of video, audio, picture, document or others. In practice, the relationship between knowledge resources and knowledge items may be one to one, one to many or many to many.

In this embodiment, between block 103 and block 104, the method may further include: the second prediction information including the second number of knowledge items is provided to the user for confirmation, and the first feedback information of the user for the second number of knowledge items is received. The first feedback information may include click operation and/or delete operation, etc. The second prediction information may be corrected according to the first feedback information to obtain a corrected second number of knowledge items. The second number after correction may be different from the second number before correction. Then, in block 104, the corrected second number of knowledge items may be used as the input of the knowledge recommendation model. Furthermore, the first feedback information or the corrected second prediction information can be provided to the first prediction algorithm model for learning. In addition, the first feedback information of the user for the second number of knowledge items can be associated with the user and stored in a database.

In addition, after block 104, the method may further include receiving second feedback information of the user for at least one knowledge resource recommended is received. The second feedback information may include click operation and browse operation for a knowledge resource. Furthermore, the second feedback information may be provided to the first prediction algorithm model for learning. In addition, the second number of knowledge items and a knowledge resource with which the user interacts more, such as the knowledge resource selected and browsed by the user, may be provided as a training sample to the knowledge recommendation model for further training. In addition, the second feedback information of the user for recommended at least one knowledge resource can be associated with the user and stored in the database.

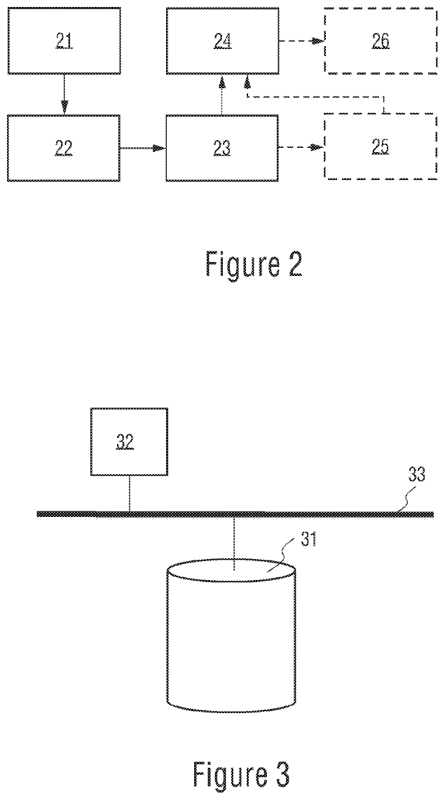

FIG. 2 is a schematic diagram illustrating an example device for knowledge recommendation incorporating teachings of the present disclosure. The device may be used to perform the method shown in FIG. 1. For the contents not disclosed in detail in the device embodiments of the present disclosure, please refer to the corresponding description in the method embodiments of the present disclosure, and will not be repeated hereinafter. As shown in the solid line part in FIG. 2, the device may include a data obtaining module 21, a first prediction module 22, a second prediction module 23 and a knowledge recommendation module 24.

The data obtaining module 21 is configured to obtain current searching information of a user for certain knowledge in factory production, job characteristic information of the user, and historical feedback information of the user for at least one knowledge item and/or knowledge resource in the past. Specifically, the original data of the current searching information submitted by the user in the form of text and/or multimedia can be obtained, and the corresponding processing module is used to perform information recognition and feature extraction on the original data to obtain the current searching information in the standard format.

The first prediction module 22 is configured to use a first prediction algorithm model for learning based on historical searching information, job feature information and historical feedback information of the user and other users to analyze information obtained by the data obtaining module 21, and to obtain first prediction information including a first number of knowledge items.

The second prediction module 23 is configured to use a second prediction algorithm model to perform fusion sorting on the first prediction information to obtain second prediction information including a second number of knowledge items; the first number is greater than the second number, and the second number is greater than or equal to 1.

The knowledge recommendation module 24 is configured to input the second number of knowledge items to a knowledge recommendation model, and recommend at least one knowledge resource output by the knowledge recommendation model to the user; the knowledge recommendation model is obtained by training with training samples formed by establishing a corresponding relationship between various knowledge resources involved in factory production and corresponding knowledge items, wherein the knowledge items are taken as input samples and corresponding knowledge resources are taken as output samples.

In some embodiments, as shown in the dotted line part in FIG. 2, the device may further include: a prediction information confirmation module 25, which is configured to provide the second prediction information including the second number of knowledge items to the user for confirmation, and receive first feedback information of the user for the second number of knowledge items, to correct the second prediction information according to the first feedback information. In addition, the first feedback information of the user for the second number of knowledge items can be associated with the user and stored in a database.

In some embodiments, the prediction information confirmation module 25 may be further configured to provide the first feedback information and/or the corrected second prediction information to the first prediction algorithm model for learning.

In some embodiments, as shown in the dotted line part of FIG. 2, the device may also further include a knowledge resource confirmation module 26, which is configured to receive second feedback information of the user for at least one recommended knowledge resource, and provide the second feedback information to the first prediction algorithm model for learning. In addition, the second feedback information of the user for the recommended at least one knowledge resource can be associated with the user and stored in the database.

In some embodiments, the knowledge resource confirmation module 26 can further provide the second number of knowledge items and a knowledge resource with which the user interacts more as a training sample to the knowledge recommendation model for further training. The device for knowledge recommendation provided by this implementation manner of the present disclosure may be specifically implemented in various manners. For example, the device for knowledge recommendation may be compiled, by using an application programming interface that complies with a certain regulation, as a plug-in that is installed in an intelligent terminal or may be encapsulated into an application program for a user to download and use.

When compiled as a plug-in, the device for knowledge recommendation may be implemented in various plug-in forms such as ocx, dll, and cab. The device for knowledge recommendation provided by this implementation manner of the present disclosure may also be implemented by using a specific technology, such as a Flash plug-in technology, a RealPlayer plug-in technology, an MMS plug-in technology, a MIDI staff plug-in technology, or an ActiveX plug-in technology.

The method for knowledge recommendation provided by this implementation manner may be stored in various storage media in an instruction storage manner or an instruction set storage manner. These storage mediums include, but are not limited to: a floppy disk, an optical disc, a DVD, a hard disk, a flash memory, a USB flash drive, a CF card, an SD card, an MMC card, an SM card, a memory stick, and an xD card.

In some embodiments, the method for knowledge recommendation provided by this implementation manner of the present disclosure may also be applied to a storage medium based on a flash memory (Nand flash), such as USB flash drive, a CF card, an SD card, an SDHC card, an MMC card, an SM card, a memory stick, and an xD card. Moreover, an operating system operated in a computer can be made, not only by executing program code read by the computer from a storage medium, but also by using an instruction based on the program code, to implement some or all actual operations, so as to implement functions of any embodiment in the foregoing embodiments.

For example, FIG. 3 is a schematic diagram illustrating another device for knowledge recommendation incorporating teachings of the present disclosure. The device may be used to perform the method shown in FIG. 1, or to implement the device shown in FIG. 2. As shown in FIG. 3, the device may include at least one memory 31 and at least one processor 32. In addition, some other components may be included, such as communication port, input/output controller, network communication interface, etc. These components communicate through bus 33, etc.

At least one memory 31 is configured to store a computer program. In an example, the computer program can be understood to include various modules of the device shown in FIG. 2. In addition, at least one memory 31 may store an operating system or the like. Operating systems include but are not limited to: Android operating system, Symbian operating system, windows operating system, Linux operating system, etc.

At least one processor 32 is configured to call the computer program stored in at least one memory 31 to perform a method for knowledge recommendation described in examples of the present disclosure. The processor 32 can be CPU, processing unit/module, ASIC, logic module or programmable gate array, etc. It can receive and send data through the communication port.

The I/O controller has a display and an input device, which is used to input, output and display relevant data.

It can be seen from above mentioned technical solutions in embodiments of the present disclosure, a knowledge recommendation model is obtained by training with training sample formed by establishing the corresponding relationship between various knowledge resources involved in factory production and corresponding various knowledge items. Then, a first prediction algorithm model is used to perform analysis on currently obtained current searching information of a user for a certain knowledge in factory production, as well as job characteristic information of the user, the historical feedback information of the user for at least one knowledge item and/or knowledge resource in the past to obtain the first prediction information including the first number of knowledge items; a second prediction algorithm model is used to perform fusion sorting on the first prediction information to obtain the second prediction information including the second quantity knowledge item; the second number of knowledge items are input to the knowledge recommendation model, and at least one knowledge resource output by the knowledge recommendation model is recommended to the user. Therefore, the knowledge recommendation in factory production is realized.

In addition, by providing the second prediction information including the second number of knowledge items to the user for confirmation, receiving the first feedback information of the user for the second number of knowledge items, and correcting the second prediction information according to the first feedback information, the accuracy of the recommendation can be improved. By providing the first feedback information and/or the corrected second prediction information to the first prediction algorithm model for learning, the prediction accuracy of the first prediction algorithm model can be improved.

Furthermore, the prediction accuracy of the first prediction algorithm model can be further improved by receiving the second feedback information of the user for at least one recommended knowledge resource and providing the second feedback information to the first prediction algorithm model for learning. In addition, by providing the second number of knowledge items and a knowledge resource with which the user interacts more as a training sample to the knowledge recommendation model for further training, the recommendation accuracy of the knowledge recommendation model can be improved.

It should be understood that, as used herein, unless the context clearly supports exceptions, the singular forms “a” (“a”, “an”, “the”) are intended to include the plural forms. It should also be understood that, “and/or” used herein is intended to include any and all possible combinations of one or more of the associated listed items. The number of the embodiments of the present disclosure are only used for description, and do not represent the merits of the implementations.

The foregoing description, for purpose of explanation, has been described with reference to specific examples. However, the illustrative discussions above are not intended to be exhaustive or to limit the present disclosure to the precise forms disclosed. Many modifications and variations are possible in view of the above teachings. The examples were chosen and described in order to best explain the principles of the present disclosure and its practical applications, to thereby enable others skilled in the art to best utilize the present disclosure and various examples with various modifications as are suited to the particular use contemplated.

What is claimed is:

1. A method for knowledge recommendation comprising:
obtaining current searching information of a user for certain knowledge in factory production, job characteristic information of the user, and historical feedback information of the user for at least one knowledge item and/or knowledge resource in the past;
using a first prediction algorithm model for learning based on historical searching information, job feature information, and historical feedback information of the user and other users to analyze obtained information, to obtain first prediction information including a first number of knowledge items;
using a second prediction algorithm model to perform fusion sorting on the first prediction information and thereby obtain second prediction information including a second number of knowledge items;
wherein the first number is greater than the second number, and the second number is greater than or equal to 1;
providing the second number of knowledge items to a knowledge recommendation model; and
recommending at least one knowledge resource output by the knowledge recommendation model to the user;
wherein the knowledge recommendation model is obtained by training with training samples formed by establishing corresponding relationship between various knowledge resources involved in factory production and corresponding knowledge items, wherein the knowledge items are taken as input samples and corresponding knowledge resources are taken as output samples.

2. The method according to claim 1, wherein:
the first prediction algorithm model comprises an algorithm model realized by a logistic regression algorithm or a collaborative filtering algorithm; and
the second prediction algorithm model comprises a CTR model realized by gradient boost decision tree algorithm+logistic regression algorithm or gradient boost decision tree algorithm+factorization machine algorithm.

3. The method according to claim 2, further comprising:
before inputting the second number of knowledge items to a knowledge recommendation model, providing the second prediction information including the second number of knowledge items to the user for confirmation, and receiving first feedback information of the user for the second number of knowledge items; and
correcting the second prediction information according to the first feedback information to obtain a corrected second number of knowledge items.

4. The method according to claim 3, further comprising providing the first feedback information or corrected second prediction information to the first prediction algorithm model for learning.

5. The method according to claim 1, further comprising:
receiving second feedback information of the user for at least one knowledge resource recommended; and
providing the second feedback information to the first prediction algorithm model for learning.

6. The method according to claim 5, further comprising providing the second number of knowledge items and a knowledge resource with which the user interacts more as a training sample to the knowledge recommendation model for further training.

7. A device for knowledge recommendation comprising:
a data obtaining module, to obtain current searching information of a user for certain knowledge in factory production, job characteristic information of the user, and historical feedback information of the user for at least one knowledge item and/or knowledge resource in the past;
a first prediction module to use a first prediction algorithm model for learning based on historical searching information, job feature information and historical feedback information of the user and other users to analyze information obtained by the data obtaining module, and to obtain first prediction information including a first number of knowledge items;
a second prediction module to use a second prediction algorithm model to perform fusion sorting on the first prediction information to obtain second prediction information including a second number of knowledge items;
wherein the first number is greater than the second number, and the second number is greater than or equal to 1; and
a knowledge recommendation module, to provide the second number of knowledge items to a knowledge recommendation model, and recommend at least one knowledge resource output by the knowledge recommendation model to the user;
wherein the knowledge recommendation model is obtained by training with training samples formed by establishing a corresponding relationship between various knowledge resources involved in factory production and corresponding knowledge items,
wherein the knowledge items are taken as input samples and corresponding knowledge resources are taken as output samples.

8. The device according to claim 7, further comprising a prediction information confirmation module, to provide the second prediction information including the second number of knowledge items to the user for confirmation, and receive first feedback information of the user for the second number of knowledge items, to correct the second prediction information according to the first feedback information.

9. The device according to claim 8, wherein the prediction information confirmation module provides the first feedback information and/or the corrected second prediction information to the first prediction algorithm model for learning.

10. The device according to claim 7, further comprising a knowledge resource confirmation module, to receive second feedback information of the user for at least one recommended knowledge resource, and provide the second feedback information to the first prediction algorithm model for learning.

11. The device according to claim 10, wherein the knowledge resource confirmation module provides the second number of knowledge items and a knowledge resource with which the user interacts more as a training sample to the knowledge recommendation model for further training.

12-13. (canceled)
